(19) United States
(12) Patent Application Publication
(10) Pub. No.: US 2024/0001735 A1
(43) Pub. Date: Jan. 4, 2024

(54) CONTROL SYSTEM FOR ARTIFICIAL INTELLIGENCE-BASED VEHICLE INTEGRATED THERMAL MANAGEMENT SYSTEM, AND METHOD OF CONTROLLING SAME

(71) Applicant: Hanon Systems, Daejeon (KR)

(72) Inventors: Joong Jae KIM, Daejeon (KR); Jeong Hoon LEE, Daejeon (KR); Wonshick KO, Daejeon (KR)

(73) Assignee: Hanon Systems, Daejeon (KR)

(21) Appl. No.: 18/036,292

(22) PCT Filed: Jan. 10, 2022
(86) PCT No.: PCT/KR2022/000377

§ 371 Date: May 10, 2023

(30) Foreign Application Priority Data
Jan. 13, 2021 (KR) 10-2021-0004752
Jan. 7, 2022 (KR) 10-2022-0002457

(51) Int. Cl. B60H 1/00

(52) U.S. Cl. CPC B60H 1/00964; B60H 1/0073; B60H 1/00735

(57) ABSTRACT

The present invention relates to a control system for an artificial intelligence-based vehicle integrated thermal management system, and a method of controlling the same. The objective of the present invention is to provide a control system for an artificial intelligence-based vehicle integrated thermal management system and a method of controlling the same, in which an optimal target value for performing optimal control of a vehicle thermal management system is calculated, a control signal for tracking the calculated optimal target value is generated, and the generated control signal may be implemented without departing from hardware characteristics of the vehicle thermal management system by implementing artificial intelligence learning control.

### TECHNICAL FIELD

The present invention relates to a control system for an artificial intelligence-based vehicle integrated thermal management system and a method of controlling the same, and more particularly, to a control system for an artificial intelligence-based vehicle integrated thermal management system and a method of controlling the same, in which a control signal for tracking an optimal target value calculated to perform optimal control of the vehicle thermal management system may be generated, and the generated control signal may implement optimal control without departing from hardware characteristics of the vehicle thermal management system.

### BACKGROUND ART

An environmental-friendly vehicle refers to a pure electric vehicle that travels by operating an electric motor, a hybrid vehicle that travels by operating an engine and an electric motor, and a fuel cell vehicle that travels by operating an electric motor with electricity generated by a fuel cell. The environmental-friendly vehicle has been developed to minimize problems with resource depletion and environmental issues, such as environmental pollution caused by exhaust gas from general internal combustion engine vehicles, global warming caused by carbon dioxide, and respiratory diseases caused by ozone production.

Like the general internal combustion engine vehicle, the environmental-friendly vehicle also requires cooling/heating devices to cool or heat various types of components such as high-voltage components. Of course, a cooling/heating air conditioning device is provided to provide and maintain a comfortable environment in a vehicle interior.

For example, the environmental-friendly vehicle includes a cooling device configured such that a water pipe for coping with heat generation is provided in a drive system or high-voltage battery including various types of power electronic components, and a coolant is supplied and circulated through the water pipe so that the coolant absorbs heat generated from the corresponding components.

A flow of the coolant is controlled by an integrated thermal management system, and the integrated thermal management system is used to control an air conditioning state so that a driver may drive in a comfortable environment.

Recently, it is possible to provide an air conditioning state optimized in consideration of a current usage environment (outside air temperature, interior temperature, etc.) even though a user does not directly control the air conditioning device. Alternatively, it is possible to provide an air conditioning state optimized in consideration of a current usage environment and the user's habits by learning the user's usage habits at ordinary times by using AI learning.

However, in case that the air conditioning state is controlled by using the AI learning in this manner, the air conditioning state may be controlled without considering hardware characteristics of a refrigerant system itself. In case that this air conditioning state is maintained continuously, there may occur problems in that cooling efficiency and cooling performance deteriorate, vehicle fuel economy (electric power economy) and vehicle drive motor output decrease, or the refrigerant system is damaged.

In this regard, Korean Patent No. 10-1199665 (“Learned Vehicle Air Conditioning Control Method”) discloses a method that may maintain an air conditioning state suitable for a user's preference at the time of automatically performing air conditioning by learning the user's usage habits. However, the method contains the above-mentioned problem in that the air conditioning state is controlled without considering the hardware characteristics of the refrigerant system.

### DOCUMENT OF RELATED ART

### Patent Document

Korean Patent No. 10-1199665 (registered on Nov. 2, 2012)

### DISCLOSURE

### Technical Problem

Accordingly, the present invention has been made in an effort to solve the above-mentioned problem in the related art, and an object of the present invention is to provide a control system for an artificial intelligence-based vehicle integrated thermal management system and a method of controlling the same, in which an optimal target value for performing optimal control of a vehicle thermal management system is calculated, a control signal for tracking the calculated optimal target value is generated, and the generated control signal may be implemented without departing from hardware characteristics of the vehicle thermal management system by implementing artificial intelligence learning control.

### Technical Solution

To achieve the above-mentioned object, a control system for an artificial intelligence-based vehicle integrated thermal management system according to the present invention optimally controls the vehicle integrated thermal management system and includes: a target value setting unit 100 configured to create a target setting value in consideration of energy efficiency in response to inputted environmental condition information; a control value computation unit 200 configured to create a target control value for tracking the target setting value on the basis of the target setting value created by the target value setting unit 100; and a control value output unit 300 configured to determine whether the target control value created by the control value computation unit 200 is included in a safety control range of a preset vehicle integrated thermal management system, the control value output unit 300 being configured to set an output control value on the basis of a determination result.

Furthermore, the target value setting unit 100 may further include: an analysis unit 110 configured to receive, from a previously connected big data server 10, collected data including environmental condition information collected under various experimental conditions, information on control of variables matched with the collected environmental condition information, and information on energy consumption by the control information, and to extract main control variables having most optimal energy efficiency in response to the environmental condition information; a DB unit 120 configured to receive the main control variables matched with the environmental condition information extracted by the analysis unit 110, make a database based on the main control variables, and store and manage the database; and a target value derivation unit 130 configured to create the target setting value by extracting the main control variables having the most optimal energy efficiency in response to the inputted environmental condition information by matching the inputted environmental condition information with information stored by the DB unit 120.

Furthermore, the analysis unit 110 may receive the collected data from the big data server 10 for each predetermined cycle, renew the main control variables extracted in response to the environmental condition information and inputted current vehicle state information, and update the DB unit 120.

Furthermore, the control value computation unit 200 may further include: an AI control unit 210 configured to create the target control value by outputting a most optimal tracking control value for tracking the target setting value created by the target value setting unit 100 on the basis of information on current states of the variables by applying two or more AI learning models; and an existing control unit 220 configured to calculate, by a previously provided hardware control means, the target control value for tracking the target setting value created by the target value setting unit 100 on the basis of the information of the current states of the variables.

Furthermore, the control value computation unit 200 may use two or more AI learning engines, each of the AI learning engines may learn input parameters including the environmental condition information, the main control variable having the most optimal energy efficiency in response to the environmental condition information, the target setting value for control to the main control variable having the most optimal energy efficiency on the basis of the environmental condition information, and the tracking control value to the target setting value based on the information on the states of the variables, and create and apply an AI learning model for outputting the most optimal tracking control value by means of the created AI learning model, and the control value computation unit 200 may further include a learning processing unit 230 configured to update the AI learning model applied to the AI control unit 210 by repeatedly performing learning by the AI learning engine for each predetermined cycle.

Furthermore, the learning processing unit 230 may analyze the input parameters, organize the input parameters into large groups on the basis of the main control variable, and organize the input parameters into small groups on the basis of a connection factor, which affects the corresponding main control variable, for each of the main control variable, and each of the AI learning engines may learn the small group of the input parameters, and the corresponding connection factor may create the AI learning model that outputs the most optimal tracking control value for controlling the main control variable.

Furthermore, the control value output unit 300 may further include: a determination unit 310 configured to determine whether the target control value, which is created by the AI control unit 210, is included in the safety control range of the preset vehicle integrated thermal management system; and a control output unit 320 configured to set the target control value, which is created by the existing control unit 220, to the output control value when a determination result of the determination unit 310 indicates that the target control value, which is created by the AI control unit 210, deviates from the safety control range, and the control output unit 320 may set the target control value, which is created by the AI control unit 210, to the output control value when the determination result of the determination unit 310 indicates that the target control value, which is created by the AI control unit 210, is included in the safety control range.

To achieve the above-mentioned object, a method of controlling an artificial intelligence-based vehicle integrated thermal management system according to the present invention optimally controls a vehicle integrated thermal management system and includes: a DB production step S100 of receiving, by a target value setting unit, from a previously connected big data server, collected data including environmental condition information collected under various experimental conditions, information on control of variables matched with the collected environmental condition information, and information on energy consumption by the control information, extracting main control variables having most optimal energy efficiency in response to the environmental condition information, receiving the main control variables matched with the extracted environmental condition information, making a database based on the main control variables, and storing and managing the database; a target value setting step S200 of creating, by a target value setting unit, a target setting value in consideration of energy efficiency in response to inputted environmental condition information; a control value setting step S300 of creating, by a control value computation unit, a target control value for tracking the target setting value, which is created by the target value setting step S200, on the basis of information on current states of the variables; a determination step S400 of determining, by a control value output unit, whether the target control value, which is created by the control value setting step S300, is included in a safety control range of a preset vehicle integrated thermal management system; and an output value setting step S500 of setting, by the control value output unit, the target control value to the output control value on the basis of a determination result of the determination step S400.

Furthermore, the DB production step S100 may receive the collected data from the big data server for each predetermined cycle, renew the main control variables extracted in response to the environmental condition information and inputted current vehicle state information, and update the database.

Furthermore, the control value setting step S300 may further include: an AI control value setting step S310 of creating the target control value by outputting a most optimal tracking control value for tracking the target setting value created on the basis of the information on the current states of the variables by applying two or more AI learning models; and an existing control value setting step S320 of calculating, by a previously provided hardware control means, the target control value for tracking the target setting value created on the basis of the information on the current states of the variables.

Furthermore, the control value setting step S300 may use two or more AI learning engines, each of the AI learning engines may learn input parameters including the environmental condition information, the main control variable having the most optimal energy efficiency in response to the environmental condition information, the target setting value for control to the main control variable having the most optimal energy efficiency on the basis of the environmental condition information, and the tracking control value to the target setting value based on the information on the states of the variables, and create and apply an AI learning model for outputting the most optimal tracking control value by means of the created AI learning model, and the control value setting step S300 may further include a learning processing step S330 of updating the AI learning model applied to the AI control value setting step S310 by repeatedly performing learning by the AI learning engine for each predetermined cycle.

Furthermore, the learning processing step S330 may analyze the input parameters, organize the input parameters into large groups on the basis of the main control variable, and organize the input parameters into small groups on the basis of a connection factor, which affects the corresponding main control variable, for each of the main control variable, and each of the AI learning engines may learn the small group of the input parameters, and the corresponding connection factor may create the AI learning model that outputs the most optimal tracking control value for controlling the main control variable.

The determination step S400 may determine whether the target control value, which is created by the AI control value setting step S310, is included in the safety control range of the preset vehicle integrated thermal management system, the output value setting step S500 may set the target control value, which is created by the AI control value setting step S310, to the output control value when a determination result of the determination step S400 indicates that the target control value, which is created by the AI control value setting step S310, is included in the safety control range, and the output value setting step S500 may set the target control value, which is created by the existing control value setting step S320, to the output control value when the determination result of the determination step S400 indicates that the target control value, which is created by the AI control value setting step S310, deviates from the safety control range.

### Advantageous Effects

According to the present invention, the control system for an artificial intelligence-based vehicle integrated thermal management system and the method of controlling the same may create the most optimal control value capable of achieving the air conditioning target by consuming minimum energy under the given environmental condition by applying the AI learning model and implement the optimal control in consideration of the hardware characteristics of the refrigerant system, which affect the vehicle thermal management other than air conditioning, without departing from the hardware characteristics of the refrigerant system.

In detail, the optimal tracking control is performed on the given target value by using the artificial intelligence controller having the multi-agent structure. In case that the target value is abnormal on the basis of the determination of the presence or absence of the normality, the target value is substituted with the safety control value, which makes it possible to implement the optimal control by means of the artificial intelligence without damaging physical characteristics of the system.

In addition, in calculating the optimal target value, such as the evaporator temperature and the supercooling degree, which is the main factor for the optimal control in terms of energy of the vehicle integrated thermal management system, it is possible to consistently update the most optimal target value by using the big data technology.

### DESCRIPTION OF DRAWINGS

FIG. 1 is an exemplified view illustrating a configuration of a control system for an artificial intelligence-based vehicle integrated thermal management system according to an embodiment of the present invention.

FIG. 2 is an exemplified view illustrating a detailed configuration of a control value computation unit 200 of the control system for an artificial intelligence-based vehicle integrated thermal management system according to the embodiment of the present invention.

FIG. 3 is an exemplified flowchart of a method of controlling the artificial intelligence-based vehicle integrated thermal management system according to the embodiment of the present invention.

### MODE FOR INVENTION

Hereinafter, a control system for an artificial intelligence-based vehicle integrated thermal management system and a method of controlling the same according to the present invention configured as described above will be described in detail with reference to the accompanying drawings.

Further, the system refers to a set of components, which includes devices, apparatuses, and means that are organized and regularly interact to perform a required function.

The control system for an artificial intelligence-based vehicle integrated thermal management system and the method of controlling the same according to the embodiment of the present invention is related to a control system and a method of controlling the same, which are capable of performing optimal control to reduce the amount of energy consumption of the vehicle integrated thermal management system in the related art, i.e., a control system and a method of controlling the same that may create a most optimal control value capable of achieving an air conditioning target by consuming minimum energy under a given environmental condition by applying an AI learning model and implement optimal control in consideration of hardware characteristics of a refrigerant system without departing from the hardware characteristics of the refrigerant system.

Briefly, the control system for an artificial intelligence-based vehicle integrated thermal management system and the method of controlling the same according to the embodiment of the present invention, in which to optimally control the integrated thermal management system for a vehicle, a target value related to an optimal evaporator temperature, a supercooling degree, and the like is set under a given environmental condition, a control value for tracking the set target value is created, and optimal control is implemented so that the created control value does not depart from the hardware characteristics of the refrigerant system.

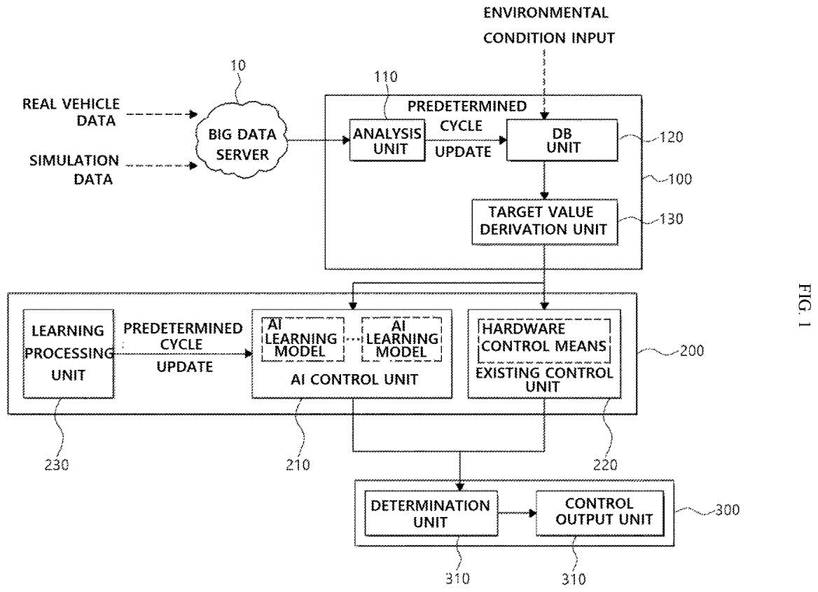

As illustrated in FIG. 1, the control system for an artificial intelligence-based vehicle integrated thermal management system according to the embodiment of the present invention may include a target value setting unit 100, a control value computation unit 200, and a control value output unit 300. In this case, the respective components may be included in a single computation processing means or the respective computation processing means and operate.

The respective components will be described in detail. The target value setting unit 100 may create a target setting value in consideration of energy efficiency in response to inputted environmental condition information. In detail, the environmental condition information may include one or more pieces of information selected from vehicle outside air information, vehicle interior temperature information, information on user's air conditioning request (a preset temperature, etc.), and information on air conditioning state control using AI that are inputted during the operation. The target setting value capable of consuming minimum energy, i.e., achieving highest energy efficiency may be created on the basis of the environmental condition information. In this case, the target setting value may include information on an optimal target value of an evaporator temperature and information on an optimal target value of a supercooling degree that are main control variables.

To this end, as illustrated in FIG. 1, the target value setting unit 100 may include an analysis unit 110, a DB unit 120, and a target value derivation unit 130.

The analysis unit 110 may receive, from a big data server 10 connected in advance, collected data including information on a current environmental condition collected under various experimental conditions (e.g., data obtained from a real vehicle test, data obtained from a simulation, etc.), information on control of variables matched with information on the current environmental condition, and information on energy consumption by the control information, and extract the main control variables (the evaporator temperature, the supercooling degree, etc.) having most optimal energy efficiency on the basis of the environmental condition information. That is, on the basis of the controllable given external environmental condition information, the control value of the main factors, such as the evaporator temperature and the supercooling degree, obtained under various experimental conditions to achieve the highest energy efficiency may be matched with the corresponding external environmental condition information.

The DB unit 120 may receive the main control variables respectively matched with the environmental condition information extracted by the analysis unit 110, make a database based on the main control variables, and store and manage the database. In addition, the DB unit 120 may make a database by matching the environmental condition information extracted by the analysis unit 110 and the main control variable as a pair, and store and manage the pairs of target values of the evaporator temperatures and the supercooling degrees to achieve the air conditioning target while consuming minimum energy on the basis of particular environmental condition information.

In this case, the analysis unit 110 may receive newly collected data from the big data server 10 for each preset predetermined cycle, newly extract the main control variables having most optimal energy efficiency on the basis of environmental condition information, and renew and update the main control variables extracted on the basis of the environmental condition information stored and managed as the database in the DB unit 120. The analysis unit 110 may renew and update the main control variables extracted in consideration of integrated thermal information from a vehicle thermal management standpoint of vehicle state information (e.g., a preset temperature which is vehicle interior air conditioning information, an interior discharge temperature according to a superheating degree, information on the amount of heat generation of a drive motor part, whether it is necessary to cool a battery, etc.) as well as the environmental condition information.

At the time of renewing and updating the main control variables of the analysis unit 110, the big data server 10 may set a range, in which the update is performed, to variable data, which adopt the collected data without change, or variable data at a level corresponding to a safety control range of the preset vehicle integrated thermal management system. The setting control may be determined depending on an intended performance improvement level (an air conditioning target level intended to be achieved while consuming minimum energy under the given environmental condition) in consideration of a computation processing level of a controller in the vehicle, i.e., hardware characteristics of a refrigerant system without departing from the computation processing level and the hardware characteristics.

Further, the big data server 10 does not newly reset the collected data after transmitting the collected data to the analysis unit 110. The big data server 10 enables the data to be consistently accumulated and analyzed as big data, thereby more stably implementing optimal control as time passes.

The target value derivation unit 130 may receive the inputted environmental condition information, i.e., one or more pieces of information selected from vehicle outside air information, vehicle interior information, information on the user's air conditioning request, and information on air conditioning state control using the AI, which are inputted during the operation, match the above-mentioned information with the information stored by the DB unit 120, extract the main control variables (e.g., information on the optimal target value of the evaporator temperature, information on the optimal target value of the supercooling degree, etc.) having most optimal energy efficiency based on the inputted environmental condition information, and create the target setting value.

The control value computation unit 200 may create a target control value for tracking the target setting value created by the target value setting unit 100. In other words, the control value computation unit 200 may use a coolant temperature or the like inputted during the operation, compute a tracking value for tracking the target setting value created by the target value setting unit 100, i.e., tracking an optimal evaporator temperature, and a tracking value for tracking an optimal supercooling degree, and create the target control value.

As illustrated in FIG. 1, the control value computation unit 200 may include an AI control unit 210 and an existing control unit 220 to more quickly and efficiently create the target control value.

The AI control unit 210 may create the target control value by outputting a most optimal tracking control value for tracking the target setting value created by the target value setting unit 100 on the basis of information on current states of variables (a current evaporator temperature, a current supercooling degree temperature, a current coolant temperature, etc.) by applying two or more AI learning models.

The AI control unit 210 may include two or more AI learning models. The AI learning models may create the most optimal target control value while operating independently or interdependently. In this case, the control value computation unit 200 may achieve a superior learning result while periodically updating the AI learning models of the AI control unit 210. To this end, as illustrated in FIG. 1, the control value computation unit 200 may further include a learning processing unit 230.

The learning processing unit 230 most preferably uses two or more AI learning engines, but this is only one embodiment of the present invention. The learning processing unit 230 may perform the learning by using the same AI learning engine and applying input parameters under different conditions.

The learning processing unit 230 may perform the learning, for each of the AI learning engines, by receiving input parameters including various external environmental condition information, the main control variables having the most optimal energy efficiency in response to the environmental condition information, the target setting value for control to the main control variables having the most optimal energy efficiency on the basis of the environmental condition information, and tracking control values to target setting values based on information on the states of the variables. It is preferred to output the most optimal tracking control value through the two or more AI learning models created by the learning result using the two or more AI learning engines. As described above, the learning processing unit 230 updates the two or more AI learning models applied to the AI control unit 210 by repeatedly performing the learning by the AI learning engines for each predetermined cycle.

In this case, the two or more AI learning models may be simultaneously or sequentially updated, or only any one selected AI learning model may be updated.

The configuration in which the learning processing unit 230 performs the learning by applying the input parameters under the different conditions will be described in detail. Before the AI learning engine performs the learning, the learning processing unit 230 may analyze the received input parameters and classify the input parameters so that the input parameters with the different conditions may be applied to each of the AI learning engines.

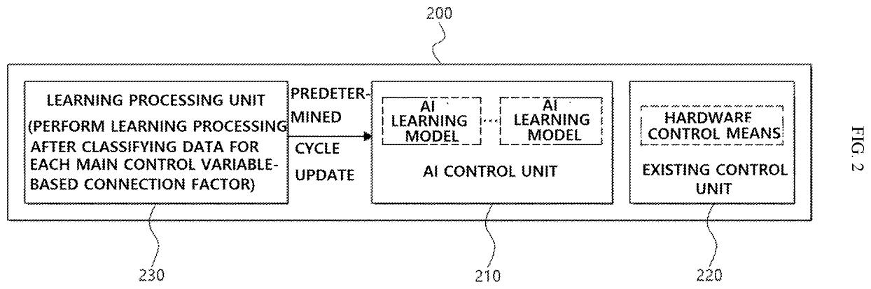

As illustrated in FIG. 2, in detail, the learning processing unit 230 may analyze the input parameters, organize the input parameters into large groups (primary grouping) on the basis of the main control variables, and organize the input parameters into small groups (secondary grouping) again on the basis of the connection factors, which affect the main control variables, for each of the main control variables, and then each of the AI learning engines may learn the small group of the input parameters.

For example, the learning processing unit 230 may analyze the input parameters, primarily group the input parameters on the basis of a refrigerant temperature of an evaporator among the main control variable, and secondarily group the input parameters on the basis of a compressor and an EXV that are connection factors that affect the refrigerant temperature of the evaporator, i.e., control the refrigerant temperature. That is, the learning processing is performed by inputting, to any one selected AI learning engine, the target setting value of the compressor for control to the refrigerant temperature having the most optimal energy efficiency on the basis of various external environmental condition information, the refrigerant temperature having the most optimal energy efficiency in response to the environmental condition information, and the environmental condition information and inputting a tracking control value (RPM control value) of the compressor to the target setting value on the basis of information on the states of the variables. The AI learning model, which is created as described above, outputs the most optimal tracking control value of the compressor on the basis of the information on the current states of the variables.

As described above, the input parameters are grouped, and the learning processing is performed by applying the grouped input parameters under the different conditions to each of the AI learning engines. Therefore, even though the control components (connection factors) are changed or the target control values (an RPM control value of the compressor, a control value of expansion amount of the EXV, etc.) are changed at the time of configuring the vehicle integrated thermal management system as the types of vehicles are changed or the technology is developed, it is possible to quickly cope with the changes by replacing only the corresponding AI learning engine or by performing relearning. Therefore, it is possible to prevent the replacement of or the relearning on all the AI learning engines to cope with some control values.

Of course, as described above, the learning processing unit 230 updates the AI learning models by the AI control unit 210 by repeatedly performing the learning by the AI learning engines for each predetermined cycle. In this case, the update of the AI learning model means the relearning performed by newly inputting the input parameters. An update range of the input parameter may be set to variable data that adopt the collected data in the big data server 10 without change or to variable data at a level corresponding to a safety control range of the preset vehicle integrated thermal management system. The setting control may be determined depending on an intended performance improvement level (an air conditioning target level intended to be achieved while consuming minimum energy under the given environmental condition) in consideration of a computation processing level of a controller in the vehicle, i.e., hardware characteristics of a refrigerant system without departing from the computation processing level and the hardware characteristics.

The existing control unit 220 may calculate the target control value for tracking the target setting value created by the target value setting unit 100 on the basis of information on current states of variables (a current evaporator temperature, a current supercooling degree temperature, a current coolant temperature, etc.) by means of a hardware control means provided in advance. That is, the existing control unit 220 may be a control result of the existing hardware controller that controls the refrigerant system in the related art.

Algorithmically, it is natural that the target control value generated by the AI control unit 210 is the most optimal tracking control value. However, because the learning is performed without considering the hardware characteristics of the refrigerant system during the process of creating the AI learning model, the target control value created by the AI control unit 210 may be, in some instances, control information that overloads the refrigerant system. In contrast, because the target control value created by the existing control unit 220 corresponds to a control logic in the related art, the target control value may be control information that is safe for the refrigerant system and does not overload the refrigerant system.

In consideration of this configuration, the control value output unit 300 may determine whether the target control value created by the control value computation unit 200 is included in the safety control range of the preset vehicle integrated thermal management system, and set the output control value on the basis of the determination result, so that the control may be performed. In other words, the control value output unit 300 may determine whether the target control value created by the control value computation unit 200 is abnormal by using the previously defined normal range of the control value (the safety control range of the integrated thermal management system made in consideration of the hardware characteristics of the refrigerant system of the vehicle).

To this end, as illustrated in FIG. 1, the control value output unit 300 may further include a determination unit 310 and a control output unit 320.

The determination unit 310 may determine whether the target control value created by the AI control unit 210 is included in the safety control range of the preset vehicle integrated thermal management system. That is, as described above, because the target control value created by the AI control unit 210 is the most optimal tracking control value, the determination unit may preferentially determine whether the target control value created by the AI control unit 210 is included in the safety control range. Therefore, the unnecessary computation amount may also be minimized.

In case that the determination result of the determination unit 310 indicates that the target control value created by the AI control unit 210 deviates from the safety control range, the control output unit 320 determines that the target control value created by the AI control unit 210 is abnormal, and the control output unit 320 sets the target control value, which is created by the existing control unit 220, to the output control value. Of course, in case that the determination result of the determination unit 310 indicates that the target control value created by the AI control unit 210 is included in the safety control range, the control output unit 320 determines that the target control value created by the AI control unit 210 is not abnormal, and the control output unit 320 may set the target control value, which is created by the AI control unit 210, to the output control value.

That is, the control value output unit 300 outputs the safety control value only when it is determined that the target control value created by the control value computation unit 200 deviates from the safety range. In other cases, the control value output unit may output an optimal control value made by the AI learning.

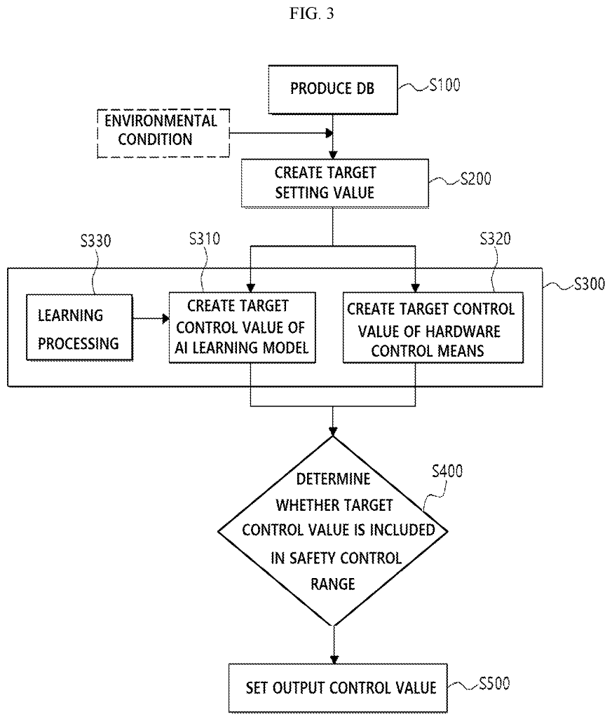

FIG. 3 is an exemplified flowchart of a method of controlling the artificial intelligence-based vehicle integrated thermal management system according to the embodiment of the present invention. The method may be a method for optimal control of the vehicle integrated thermal management system and include a DB production step S100, a target value setting step S200, a control value setting step S300, a determination step S400, and an output value setting step S500.

The respective steps will be described in detail. In the DB production step S100, the target value setting unit 100 may receive, from the big data server 10 connected in advance, collected data including information on a current environmental condition collected under various experimental conditions (e.g., data obtained from a real vehicle test, data obtained from a simulation, etc.), information on control of variables matched with information on the current environmental condition, and information on energy consumption by the control information, extract the main control variables (the evaporator temperature, the supercooling degree, etc.) having most optimal energy efficiency on the basis of the environmental condition information, match the data and the main control variables, make a database based on the data and the main control variables, and store and manage the database.

In detail, the DB production step S100 may receive collected data including current environmental condition information obtained by controlling external environmental condition information under various experimental conditions, information on control of the variables matched with the current environmental condition information, and information on energy consumption made by the control information, and match the collected data with the external environmental condition information corresponding to the control value of the main factors such as the evaporator temperature and the supercooling degree that may achieve highest energy efficiency.

Therefore, it is possible to make the database by matching the extracted environmental condition information and the main control variable as a pair, and store and manage the pairs of target values of the evaporator temperatures and the supercooling degrees to achieve the air conditioning target while consuming minimum energy on the basis of particular environmental condition information.

In this case, the DB production step S100 may receive newly collected data from the big data server 10 for each preset predetermined cycle, newly extract the main control variables having most optimal energy efficiency on the basis of environmental condition information, and renew and update the main control variables extracted on the basis of the environmental condition information stored and managed.

Further, the DB production step S100 may renew and update the main control variables extracted in consideration of integrated thermal information from a vehicle thermal management standpoint of vehicle state information (e.g., a preset temperature which is vehicle interior air conditioning information, an interior discharge temperature according to a superheating degree, information on the amount of heat generation of a drive motor part, whether it is necessary to cool a battery, etc.) as well as the environmental condition information.

In this case, at the time of performing the update by means of the big data server 10 in the DB production step S100, the big data server 10 may set a range, in which the update is performed, to variable data, which adopt collected data without change, or variable data at the level corresponding to the safety control range of the preset vehicle integrated thermal management system. The setting control may be determined depending on an intended performance improvement level (an air conditioning target level intended to be achieved while consuming minimum energy under the given environmental condition) in consideration of a computation processing level of a controller in the vehicle, i.e., hardware characteristics of a refrigerant system without departing from the computation processing level and the hardware characteristics.

The target value setting step S200 may create, by the target value setting unit 100, a target setting value in consideration of energy efficiency in response to inputted environmental condition information.

The target setting value capable of consuming minimum energy, i.e., achieving highest energy efficiency may be created on the basis of the environmental condition information. In this case, the target setting value may include information on an optimal target value of an evaporator temperature and information on an optimal target value of a supercooling degree that are main control variables.

In other words, the environmental condition information may include one or more pieces of information selected from vehicle outside air information, vehicle interior temperature information, information on user's air conditioning request (a preset temperature, etc.), and information on air conditioning state control using AI that are inputted during the operation. The target setting value capable of consuming minimum energy, i.e., achieving highest energy efficiency may be created on the basis of the environmental condition information. In this case, the target setting value may include information on an optimal target value of an evaporator temperature and information on an optimal target value of a supercooling degree that are main control variables.

That is, the target value setting step S200 may receive the environmental condition information inputted during the operation, i.e., one or more pieces of information selected from vehicle outside air information, vehicle interior information, information on the user's air conditioning request, and information on air conditioning state control using the AI, which are inputted during the operation, match the above-mentioned information with the databases stored and managed by the DB production step S100, extract the main control variables (e.g., information on the optimal target value of the evaporator temperature, information on the optimal target value of the supercooling degree, etc.) having most optimal energy efficiency based on the inputted environmental condition information, and create the target setting value.

The control value setting step S300 may create, by the control value computation unit 200, the target control value for tracking the target setting value created by the target value setting step S200 based on the information on the current states of the variables.

That is, the control value setting step S300 may use a coolant temperature or the like inputted during the operation, compute a tracking value for tracking the target setting value created by the target value setting step S200, i.e., tracking an optimal evaporator temperature, and a tracking value for tracking an optimal supercooling degree, and create the target control value.

As illustrated in FIG. 3, the control value setting step S300 may include an AI control value setting step S310 and an existing control value setting step S320.

The AI control value setting step S310 may create the target control value by outputting a most optimal tracking control value for tracking the target setting value created by the target value setting step S200 on the basis of information on current states of variables (a current evaporator temperature, a current supercooling degree temperature, a current coolant temperature, etc.) by applying two or more AI learning models.

The two or more AI learning models applied to the AI control value setting step S310 may create the most optimal target control value while operating independently or interdependently.

In this case, the control value setting step S300 may achieve a superior learning result while periodically updating the AI learning models. To this end, as illustrated in FIG. 3, the control value setting step S300 may further include a learning processing step S330.

The learning processing step S330 most preferably uses two or more AI learning engines, but this is only one embodiment of the present invention. The learning processing step S330 may perform the learning by using the same AI learning engine and applying input parameters under different conditions.

In detail, the learning processing step S330 may perform the learning, for each of the AI learning engines, by receiving input parameters including various external environmental condition information, the main control variables having the most optimal energy efficiency in response to the environmental condition information, the target setting value for control to the main control variables having the most optimal energy efficiency on the basis of the environmental condition information, and tracking control values to target setting values based on information on the states of the variables. It is preferred to output the most optimal tracking control value through the two or more AI learning models created by the learning result using the two or more AI learning engines. Of course, the two or more AI learning models applied to the AI control value setting step S310 are updated by repeatedly performing the learning by the AI learning engines for each predetermined cycle.

In this case, the two or more AI learning models may be simultaneously or sequentially updated, or only any one selected AI learning model may be updated.

In addition, to perform the learning by applying the input parameters under the different conditions to each of the AI learning engines, the learning processing step S330 analyzes the received input parameters and classify the input parameters so that the input parameters with the different conditions may be applied to each of the AI learning engines before the AI learning engine performs the learning.

In detail, the learning processing step S330 may analyze the input parameters, organize the input parameters into large groups (primary grouping) on the basis of the main control variables, and organize the input parameters into small groups (secondary grouping) again on the basis of the connection factors, which affect the main control variables, for each of the main control variables, and then each of the AI learning engines may learn the small group of the input parameters.

For example, it is possible to analyze the input parameters, primarily group the input parameters on the basis of a refrigerant temperature of an evaporator among the main control variable, and secondarily group the input parameters on the basis of a compressor and an EXV that are connection factors that affect the refrigerant temperature of the evaporator, i.e., control the refrigerant temperature. That is, the learning processing is performed by inputting, to any one selected AI learning engine, the target setting value of the compressor for control to the refrigerant temperature having the most optimal energy efficiency on the basis of various external environmental condition information, the refrigerant temperature having the most optimal energy efficiency in response to the environmental condition information, and the environmental condition information and inputting a tracking control value (RPM control value) of the compressor to the target setting value on the basis of information on the states of the variables. The AI learning model, which is created as described above, outputs the most optimal tracking control value of the compressor on the basis of the information on the current states of the variables.

As described above, the input parameters are grouped, and the learning processing is performed by applying the grouped input parameters under the different conditions to each of the AI learning engines. Therefore, even though the control components (connection factors) are changed or the target control values (an RPM control value of the compressor, a control value of expansion amount of the EXV, etc.) are changed at the time of configuring the vehicle integrated thermal management system as the types of vehicles are changed or the technology is developed, it is possible to quickly cope with the changes by replacing only the corresponding AI learning engine or by performing relearning. Therefore, it is possible to prevent the replacement of or the relearning on all the AI learning engines to cope with some control values.

Nevertheless, the learning processing step S330 updates the AI learning models by the AI control value setting step S310 by repeatedly performing the learning by the AI learning engine for each predetermined cycle. In this case, the update of the AI learning model means the relearning performed by newly inputting the input parameters. An update range of the input parameter may be set to variable data that adopt the collected data in the big data server 10 without change or to variable data at a level corresponding to a safety control range of the preset vehicle integrated thermal management system. The setting control may be determined depending on an intended performance improvement level (an air conditioning target level intended to be achieved while consuming minimum energy under the given environmental condition) in consideration of a computation processing level of a controller in the vehicle, i.e., hardware characteristics of a refrigerant system without departing from the computation processing level and the hardware characteristics.

The existing control value setting step S320 may calculate the target control value for tracking the target setting value created on the basis of information on current states of variables (a current evaporator temperature, a current supercooling degree temperature, a current coolant temperature, etc.) by means of a hardware control means provided in advance. That is, this may be a control result of the existing hardware controller that controls the refrigerant system in the related art.

The determination step S400 may determine whether the target control value created by the control value setting step S300 in the control value output unit 300 is included in the safety control range of the preset vehicle integrated thermal management system.

It is possible to determine whether the target control value created by the AI control value setting step S310 is included in the safety control range of the preset vehicle integrated thermal management system. Algorithmically, the target control value created by the AI control value setting step S310 is the most optimal tracking control value. Therefore, it is possible to preferentially determine whether the target control value created by the AI control value setting step S310 is included in the safety control range. Therefore, the unnecessary computation amount may also be minimized.

The output value setting step S500 may set, by the control value output unit 300, the target control value to the output control value in response to the determination result of the determination step S400.

In detail, in case that the determination result of the determination step S400 indicates that the target control value, which is created by the AI control value setting step S300, is included in the safety control range, the output value setting step S500 may set the target control value, which is created by the AI control value setting step S300, to the output control value. In case that the target control value, which is created by the AI control value setting step S300, deviates from the safety control range, the output value setting step S500 sets the target control value, which is created by the existing control value setting step S320, to the output control value.

That is, it is possible to output the safety control value only when it is determined that the created target control value deviates from the safety range. In other cases, it is possible to output an optimal control value made by the AI learning.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Target value setting unit
110: Analysis unit
120: DB unit
130: Target value derivation unit
200: Control value computation unit
210: AI control unit
220: Existing control unit
230: Learning processing unit
300: Control value output unit
310: Determination unit
320: Control output unit

1. A control system for an artificial intelligence-based vehicle integrated thermal management system, which optimally controls the vehicle integrated thermal management system, the control system comprising:
a target value setting unit 100 configured to create a target setting value in consideration of energy efficiency in response to inputted environmental condition information;
a control value computation unit 200 configured to create a target control value for tracking the target setting value on the basis of the target setting value created by the target value setting unit 100; and
a control value output unit 300 configured to determine whether the target control value created by the control value computation unit 200 is included in a safety control range of a preset vehicle integrated thermal management system, the control value output unit 300 being configured to set an output control value on the basis of a determination result.

2. The control system of claim 1, wherein the target value setting unit 100 further comprises:
an analysis unit 110 configured to receive, from a previously connected big data server 10, collected data including environmental condition information collected under various experimental conditions, information on control of variables matched with the collected environmental condition information, and information on energy consumption by the control information, and to extract main control variables having most optimal energy efficiency in response to the environmental condition information;
a DB unit 120 configured to receive the main control variables matched with the environmental condition information extracted by the analysis unit 110, make a database based on the main control variables, and store and manage the database; and
a target value derivation unit 130 configured to create the target setting value by extracting the main control variables having the most optimal energy efficiency in response to the inputted environmental condition information by matching the inputted environmental condition information with information stored by the DB unit 120.

3. The control system of claim 2, wherein the analysis unit 110 receives the collected data from the big data server 10 for each predetermined cycle, renews the main control variables extracted in response to the environmental condition information and inputted current vehicle state information, and updates the DB unit 120.

4. The control system of claim 1, wherein the control value computation unit 200 further comprises:
an AI control unit 210 configured to create the target control value by outputting a most optimal tracking control value for tracking the target setting value created by the target value setting unit 100 on the basis of information on current states of the variables by applying two or more AI learning models; and
an existing control unit 220 configured to calculate, by a previously provided hardware control means, the target control value for tracking the target setting value created by the target value setting unit 100 on the basis of the information of the current states of the variables.

5. The control system of claim 4, wherein the control value computation unit 200 uses two or more AI learning engines,
wherein each of the AI learning engines learns input parameters including the environmental condition information, the main control variable having the most optimal energy efficiency in response to the environmental condition information, the target setting value for control to the main control variable having the most optimal energy efficiency on the basis of the environmental condition information, and the tracking control value to the target setting value based on the information on the states of the variables, and creates and applies an AI learning model for outputting the most optimal tracking control value by means of the created AI learning model, and
wherein the control value computation unit 200 further comprises a learning processing unit 230 configured to update the AI learning model applied to the AI control unit 210 by repeatedly performing learning by the AI learning engine for each predetermined cycle.

6. The control system of claim 5, wherein the learning processing unit 230 analyzes the input parameters, organizes the input parameters into large groups on the basis of the main control variable, and organizes the input parameters into small groups on the basis of a connection factor, which affects the corresponding main control variable, for each of the main control variable, and
wherein each of the AI learning engines learns the small group of the input parameters, and the corresponding connection factor creates the AI learning model that outputs the most optimal tracking control value for controlling the main control variable.

7. The control system of claim 4, wherein the control value output unit 300 further comprises:
a determination unit 310 configured to determine whether the target control value, which is created by the AI control unit 210, is included in the safety control range of the preset vehicle integrated thermal management system; and
a control output unit 320 configured to set the target control value, which is created by the existing control unit 220, to the output control value when a determination result of the determination unit 310 indicates that the target control value, which is created by the AI control unit 210, deviates from the safety control range, and
wherein the control output unit 320 sets the target control value, which is created by the AI control unit 210, to the output control value when the determination result of the determination unit 310 indicates that the target control value, which is created by the AI control unit 210, is included in the safety control range.

8. A method of controlling an artificial intelligence-based vehicle integrated thermal management system, which optimally controls a vehicle integrated thermal management system, the method comprising:
a DB production step S100 of receiving, by a target value setting unit, from a previously connected big data server, collected data including environmental condition information collected under various experimental conditions, information on control of variables matched with the collected environmental condition information, and information on energy consumption by the control information, extracting main control variables having most optimal energy efficiency in response to the environmental condition information, receiving the main control variables matched with the extracted environmental condition information, making a database based on the main control variables, and storing and managing the database;
a target value setting step S200 of creating, by a target value setting unit, a target setting value in consideration of energy efficiency in response to inputted environmental condition information;
a control value setting step S300 of creating, by a control value computation unit, a target control value for tracking the target setting value, which is created by the target value setting step S200, on the basis of information on current states of the variables;
a determination step S400 of determining, by a control value output unit, whether the target control value, which is created by the control value setting step S300, is included in a safety control range of a preset vehicle integrated thermal management system; and
an output value setting step S500 of setting, by the control value output unit, the target control value to the output control value on the basis of a determination result of the determination step S400.

9. The method of claim 8, wherein the DB production step S100 receives the collected data from the big data server for each predetermined cycle, renews the main control variables extracted in response to the environmental condition information and inputted current vehicle state information, and updates the database.

10. The method of claim 8, wherein the control value setting step S300 further comprises:
an AI control value setting step S310 of creating the target control value by outputting a most optimal tracking control value for tracking the target setting value created on the basis of the information on the current states of the variables by applying two or more AI learning models; and
an existing control value setting step S320 of calculating, by a previously provided hardware control means, the target control value for tracking the target setting value created on the basis of the information on the current states of the variables.

11. The method of claim 10, wherein the control value setting step S300 uses two or more AI learning engines,
wherein each of the AI learning engines learns input parameters including the environmental condition information, the main control variable having the most optimal energy efficiency in response to the environmental condition information, the target setting value for control to the main control variable having the most optimal energy efficiency on the basis of the environmental condition information, and the tracking control value to the target setting value based on the information on the states of the variables, and creates and applies an AI learning model for outputting the most optimal tracking control value by means of the created AI learning model, and
wherein the control value setting step S300 further comprises a learning processing step S330 of updating the AI learning model applied to the AI control value setting step S310 by repeatedly performing learning by the AI learning engine for each predetermined cycle.

12. The method of claim 11, wherein the learning processing step S330 analyzes the input parameters, organizes the input parameters into large groups on the basis of the main control variable, and organizes the input parameters into small groups on the basis of a connection factor, which affects the corresponding main control variable, for each of the main control variable, and
wherein each of the AI learning engines learns the small group of the input parameters, and the corresponding connection factor creates the AI learning model that outputs the most optimal tracking control value for controlling the main control variable.

13. The method of claim 10, wherein the determination step S400 determines whether the target control value, which is created by the AI control value setting step S310, is included in the safety control range of the preset vehicle integrated thermal management system,
wherein the output value setting step S500 sets the target control value, which is created by the AI control value setting step S310, to the output control value when a determination result of the determination step S400 indicates that the target control value, which is created by the AI control value setting step S310, is included in the safety control range, and
wherein the output value setting step S500 sets the target control value, which is created by the existing control value setting step S320, to the output control value when the determination result of the determination step S400 indicates that the target control value, which is created by the AI control value setting step S310, deviates from the safety control range.
